(19) United States
(12) Patent Application Publication
(10) Pub. No.: US 2008/0307474 A1
(43) Pub. Date: Dec. 11, 2008

(54) Connectivity for consumer electronics products

(75) Inventors: James M. Muth, Santa Ana, CA (US); Scott Cunningham, Newport Beach, CA (US); Jeffrey Swinehart, Centennial, CO (US)

Correspondence Address: FARJAMI & FARJAMI LLP, 26522 LA ALAMEDA AVENUE, SUITE 360, MISSION VIEJO, CA, 92691, US

(73) Assignee: BROADCOM CORPORATION, Irvine, CA (US)

(21) Appl. No.: 12/001,213

(22) Filed: Dec. 10, 2007

Related U.S. Application Data
(60) Provisional application No. 60/933,993, filed on Jun. 7, 2007.

(51) Int. Cl. H04N 7/173; G06F 15/16

(52) U.S. Cl. 725/104; 709/227; 725/133

(57) ABSTRACT

There is provided a method for use by a consumer electronics product (CEP) for communicating information with a CEP service provider. The method comprises providing a request by a CEP device to a CEP local communication device for a local area connection; detecting a local-area-enabled communication device by the CEP local communication device in response to the request; establishing a local area connection with the local-area-enabled communication device after the detecting; causing the local-area-enabled communication device to establish a wide area connection with the CEP service provider; providing the information to the CEP service provider via the local area connection and the wide area connection. In one aspect, the CEP may be a set top box. Further, the local area connection may be based on one of a bluetooth connection or an 802.11 connection.

### RELATED APPLICATIONS

This application claims priority from U.S. Provisional Application No. 60/933,993, filed on Jun. 7, 2007, which is hereby incorporated by reference in its entirety.

### BACKGROUND OF THE INVENTION

1. Field of the Invention

The present invention relates generally to communication devices. More particularly, the present invention relates to providing connectivity for consumer electronics products using communication devices.

2. Background Art

Today, upon the purchase of electronic products, consumers are encouraged or sometimes required to register their electronics products with the manufacturer in order to receive a warranty or an extended warranty, or with the service provider in order to receive service. Further, as a result of the registration, consumers may receive news about updates, upgrades and other important information about the purchased products. In addition, consumers may be required to furnish certain information to the manufacturer or service provider in order to receive a rebate for the purchased products. However, product registration can be cumbersome and time consuming, since the consumer must gather certain information from the purchased product and fill out a form either online or in writing.

Even more, today, consumers of electronics products whom may desire to update, upgrade or receive certain programming or information from service providers must connect the electronics product to a wired connection, such as a PSTN (Public Switched Telephone Network) telephone line or an Ethernet cable to request and receive such information. For example, such consumer product may be a set top box (STB), where the consumer wishes to order a pay-per-view event, or the STB service provider wishes to retrieve movies ordered over the course of the previous month.

FIG. 1 illustrates conventional communication system 100 including a satellite STB 110 in communication with satellite service provider 150 via a telephone connection. As shown, satellite STB 110 includes STB chipset 120 for operation of satellite STB 110, and modem 130 for providing data connection between satellite STB 110 and satellite service provider 150 over telephone line 135 via PSTN 140. To order a pay-per-view event, a user of satellite STB 110 is provided with a list of events by satellite STB 110, and once the user selects a desired event, STB chipset 120 instructs modem 130 to dial a predefined telephone number. Once a modem connection is established with satellite service provider 150, satellite service provider 150 receives the user's selection over telephone line 135 and via PSTN network 140, and satellite service provider 150 authorizes the desired event for satellite STB 110, which will be broadcast to satellite STB 110 via satellite 160. In addition, satellite service provider 150 periodically polls satellite STB 110 to retrieve purchase history, such as information on movies ordered for billing purposes, and to provide credit limit authorization. This is done through PSTN 140 and telephone line 135 to modem 130.

However, satellite STB 110 may not be located near telephone line 135 or other alternative means of data communication, such as a cable modem, or a DSL modem. In some cases, the user may not even have an available uplink access at all, such as telephone line 135. Without an uplink, it is more difficult to order pay per view events, and is impossible to retrieve order information from the satellite STB 110. Similarly, without an uplink, it is not possible for the user to interactively register an electronic product, receive an update, or purchase an upgrade.

Accordingly, there is a strong need in the art to offer consumers a more convenient and easy-to-use approach to provide, request and receive information for their consumer electronics products.

### SUMMARY OF THE INVENTION

There is provided method and system for connectivity for consumer electronics products, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates a conventional communication system including a set top box in communication with a satellite service provider via a local wired connection;

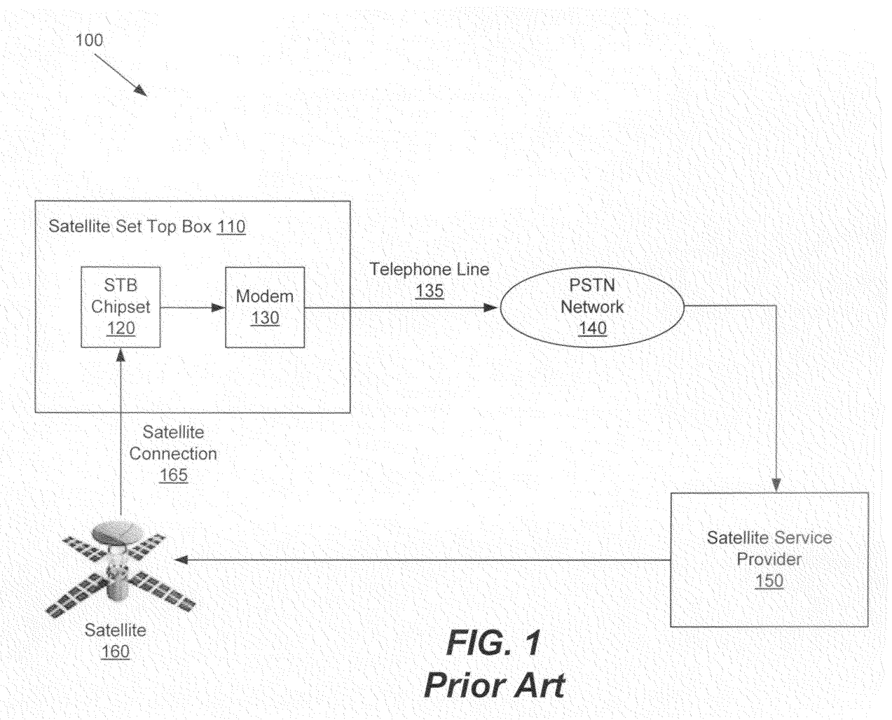

FIG. 2 illustrates a communication system including a satellite set top box in communication with a satellite service provider via a local wireless connection and a cellular connection, in accordance with one embodiment of the present invention;

FIG. 3 illustrates a communication system including a consumer electronics product in communication with a service provider via a local wireless connection and a wide area connection, in accordance with one embodiment of the present invention; and

FIG. 4 illustrates a process flow diagram for use by a communication system for facilitating a communication between an STB and an STB service provider via a local connection and a wide area connection, in accordance with one embodiment of the present invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art. The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

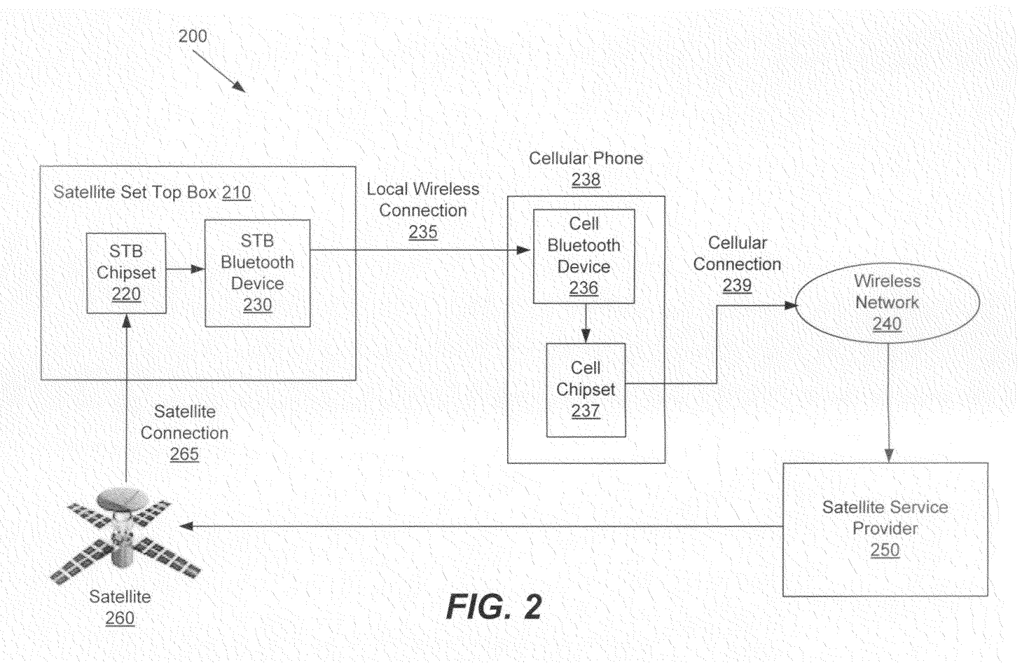

FIG. 2 illustrates communication system 200 including satellite STB 210 in communication with satellite service provider 250 via local (or local area) wireless connection 235 and cellular connection 239, in accordance with one embodiment of the present invention. As shown, satellite STB 210 includes STB chipset 220 for operation of satellite STB 210, and STB bluetooth device 230 for providing data connection between satellite STB 210 and cellular device or phone 238. Cellular phone 238 includes cell bluetooth device 236 for communication with STB bluetooth device 230 over local wireless connection 235, and cellular phone 238 also includes cell chipset 237 for communication over cellular connection 239 with satellite service provider 250 via wireless network 240.

In one embodiment, to order a pay-per-view event, a user of satellite STB 210 is provided with a list of events, and once the user selects a desired event, STB chipset 220 instructs STB bluetooth device 230 to establish local wireless connection 235 with cell bluetooth device 236 of cellular phone 238, in accordance with the known bluetooth communication standard. Once local wireless connection 235 is established, satellite STB 210 requests cellular phone 238 to dial a predefined phone number for satellite service provider 250. In one embodiment, satellite STB 210 may provide the predefined phone number to cellular phone 238 via local wireless connection 235. In yet another embodiment, the predefined phone number may be stored in cellular phone 238, and the number is dialed upon a request by satellite STB 210 for a connection with satellite service provider 250.

After receiving a request for connection by cellular phone 238, cellular phone 238 places a call to satellite service provider 250 using the predefined phone number through wireless network 240. Once cellular connection 239 is established between cellular phone 238 and satellite service provider 250, cellular phone 238 informs satellite STB 210 of its readiness, via local wireless connection 235, to receive information about the selected desired event by the user. In one embodiment, however, satellite STB 210 may provide such information at the time it is requesting cellular phone 238 to place a call to satellite service provider 250. The information about the selected desired event can be transmitted using information packets over local wireless connection 235, which is received by cell bluetooth device 236.

At this point cell chipset 237 may use a variety of schemes to communicate the information about the selected desired event to satellite service provider 250 via cellular connection 239. For example, in one embodiment, cell chipset 237 may encode the information about the selected desired event using single or dual tones, such as well-known DTMF (dual-tone multi-frequency). In such embodiment, sixteenth (16) different tones may be combined in a number of ways to encode the information about the selected desired event to satellite service provider 250. One such approach is described in U.S. Provisional Application Ser. No. 60/971,287, having a common assignee and titled “Back Channel Communication for Set Top Box Device,” filed Sep. 11, 2007, which is hereby incorporated by reference in its entirety. Upon receiving the tones, satellite service provider 250 decodes the tones to retrieve the information, and authorizes the event for satellite STB 210 via satellite 260 and through satellite connection 265. Of course, in one embodiment, the authorization may be provided by satellite service provider 250 through cellular phone 238 and local wireless connection 235.

In another scheme, rather than using a set of tones for transmitting encoded information over cellular connection 239, cell chip 237 may transmit the information about the selected desired event to satellite service provider 250 using a text message service, such as SMS (Short Message Service). In one embodiment, the information about the selected desired event may be compressed or encoded, and the compressed text message is sent to satellite service provider 250. Upon receiving the text message, satellite service provider 250 processes or decodes the text message to retrieve the information, and authorizes the event for satellite STB 210 via satellite 260 and through satellite connection 265. In one embodiment, the authorization may be provided by satellite service provider 250 as a reply text message to cellular phone 238, which is then provided via local wireless connection 235 to satellite STB 210.

In yet another scheme, cell chip 237 may transmit the information about the selected desired event to satellite service provider 250 using a data service supported by cell chipset 236, such as EDGE, GPRS, etc. In one embodiment, the information about the selected desired event may be compressed or encoded, and the compressed data is sent to satellite service provider 250. Upon receiving the data message, satellite service provider 250 processes or decodes the data message to retrieve the information, and authorizes the event for satellite STB 210 via satellite 260 and through satellite connection 265. In one embodiment, the authorization may be provided by satellite service provider 250 as a reply data message to cellular phone 238 using the data service, which is then provided via local wireless connection 235 to satellite STB 210. In another embodiment, the data messages may also be communicated via electronic mail.

It should be noted that communication system 200 may also be utilized for exchanging other information and data between satellite STB 210 and satellite service provider 250, such as software upgrade, maintenance information, programming upgrade, software patches, control configurations, instruction to reset satellite STB 210, etc. Further, communication system 200 is not limited to satellite communications, and satellite STB 210 may also be a cable STB. Even more, although cellular phone 238 is utilized in communication system 200, wide area connection for extending local wireless connection 235 may be provided by means other than cellular connection 239, such as DSL connection, cable connection, analog modem connection, etc. Also, in one embodiment, local wireless connection 235 may use wireless technologies other than bluetooth, such as 802.11.

It should also be noted that in addition to a request by the user, satellite service provider 250 may also periodically poll satellite STB 210 to retrieve purchase history, such as information on movies ordered for billing purposes, and to provide credit limit authorization. In one embodiment of the present invention, such information can also be provided over local wireless connection 235 to satellite service provider 250.

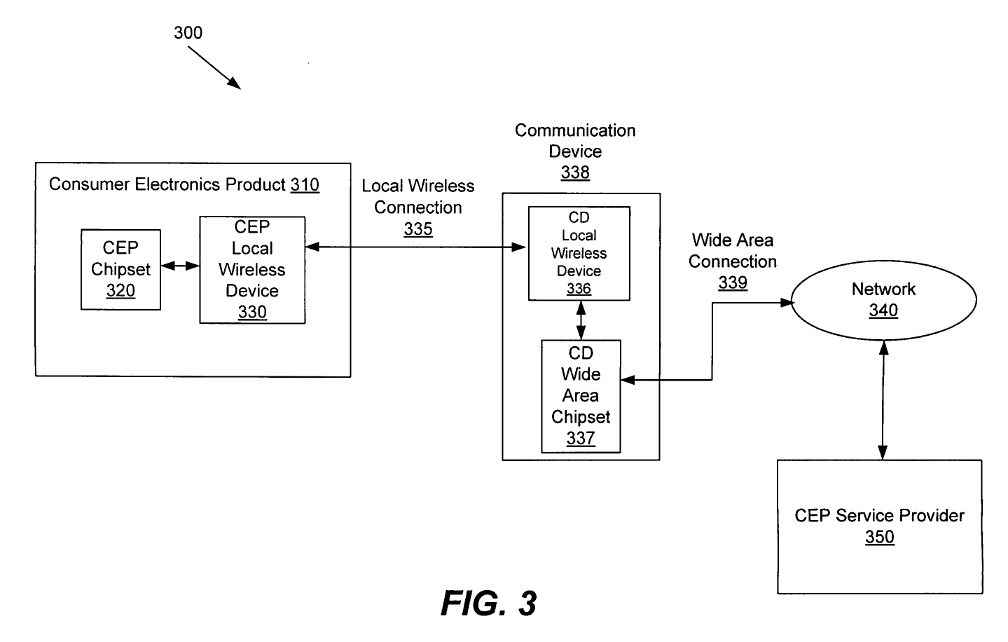

FIG. 3 illustrates communication system 300 including consumer electronics product (CEP) 310 in communication with CEP service provider 350 via local (or local area) wireless connection 335 and wide area connection 339, in accordance with one embodiment of the present invention. As shown, CEP 310 includes CEP chipset 320 for operation of CEP 310, and CEP local wireless device 330 for providing data connection between CEP 310 and communication device 338. CEP 310 may be any electronics products, such as VCRs, DVD players, TVs, copiers, washers, refrigerators, remote controls, headsets, STBs, remote controls, headsets, etc.

Communication device (CD) 338 includes CD local wireless device 336 for communication with CEP local wireless device 330 over local wireless connection 335. CD local wireless device 336 and CEP local wireless device 330 may be able to establish one or more local wireless connections, based on Bluetooth, 802.11. Communication device 338 also includes CD wide area chipset 337 for communication over wide area connection 339 with CEP service provider 350 via wireless network 340. Wide area connection 339 may be a cellular connection, a WiMax connection, a cable modem connection, a DSL modem connection, an analog modem connection, or the like. Communication device 338 may be a cellular phone, a computer, or any communication device that is capable of communicating with CEP 310 via a local wireless connection and with CEP service provider 350 via wired or wireless wide area connection.

In one embodiment, to register CEP 310 with CEP service provider 350, a user of CEP 310 is provided with a menu of options or an option to register CEP 310. Once the user elects to register CEP 310, CEP chipset 310 instructs CEP local wireless device 330 to establish local wireless connection 335 with CD local wireless device 336 of communication device 338, in accordance with a local communication protocol, such as Bluetooth, 802.11. Once local wireless connection 335 is established, CEP 310 requests communication device 338 to establish a communication with CEP service provider 350. In one embodiment, CEP 310 may provide the predefined contact information for CEP service provider 350 to communication device 338 via local wireless connection 335. In yet another embodiment, communication device 338 may have stored such contact information or may be able to obtain the contact information from another source, such as a web location.

After receiving a request for connection by communication device 338, communication device 338 contacts CEP service provider 350 using the predefined contact information through network 340. The predefined contact information may be a phone number or a web address for CEP service provider 350. Once wide area connection 339 is established between communication device 338 and CEP service provider 350, communication device 338 informs CEP service provider 350 of a registration request from CEP 310. In response, CEP service provider 350 may transmit various inquiries to CEP 310 via wide area connection 339 and local wireless connection 335, and the user may respond to such inquiries via local wireless connection 335 and wide area connection 339. The inquiries may include user's personal information and product information. In one embodiment, CEP 310 may already include the inquiries, and rather than transmitting such inquiries by CEP service provider 350, CEP service provider 350 may transmit an initiation request to CEP 310 for initiating the inquiry process, where the user provides the responses to such inquiries to CEP 310, which are transmitted to CEP service provider 350 via local wireless connection 335 and wide area connection 339.

As described in conjunction with FIG. 2 above, CD wide area chipset 337 may use a variety of schemes to communicate the information and responses to CEP service provider 350 via wide area connection 339. For example, in one embodiment, CD wide area chipset 337 may encode the information using single or dual tones, such as well-known DTMF. Upon receiving the tones, CEP service provider 350 decodes the tones to retrieve the information, and proceeds with the registration process. In another scheme, rather than using a set of tones for transmitting encoded information over wide area connection 339, CD wide area chipset 337 may transmit the registration information to CEP service provider 350 using a text message service, such as SMS. In one embodiment, the registration information may be compressed or encoded, and the compressed text message is sent to CEP service provider 350. Upon receiving the text message, CEP service provider 350 processes or decodes the text message to retrieve the registration information, and authorizes the registration for CEP 310 via a reply text message to communication device 338, which is then provided via local wireless connection 335 to CEP 310. In yet another scheme, CD wide area chipset 337 may transmit the registration information to CEP service provider 350 using a data service supported by cell chipset 336, such as EDGE, GPRS, etc. In one embodiment, the registration information may be compressed or encoded, and the compressed data is sent to CEP service provider 350. Upon receiving the data message, CEP service provider 350 processes or decodes the data message to retrieve the registration information, and authorizes the registration for CEP 310 via a reply data message to communication device 338 using the data service, which is then provided via local wireless connection 335 to CEP 310.

Communication system 300 may, of course, be utilized for exchanging data other than registration information between CEP 310 and CEP service provider 350, such as software upgrade, maintenance information, programming upgrade, software patches, control configurations, instruction to reset CEP 310, etc. In embodiments where CEP 310 must remain within a defined geographic area, the present geographic area of CEP 310 may also be transmitted to CEP service provider 350. Due to the close vicinity of communication device 338 to CEP 310, the present geographic area of communication device 310 may be transmitted to CEP service provider 350 instead.

Inn one embodiment, CEP 310 with embedded CEP local wireless device 330 can contact a database of CEP service provider 350 to determine if any updates are available, such as iTunes requesting if user wants updated software for the iPod every time the iPod is plugged in, and Adobe requesting if user wants updated software any time the program is launched. According to one example method, on power-up, CEP local wireless device 330 looks for CD local wireless device 336, such as a bluetooth device in a cell phone, and if detected, local wireless connection 335 is established, and CEP uses communication device 338 as a gateway to access the database at CEP service provider 350 to check for updates. If such updates are available, the user is then prompted as to whether a download is desired, and after acceptance, the download is initiated. As a result, a need for a permanent connection means between a consumer electronics product and service provider database is eliminated, and a temporary local wireless connection can be created on an ad hoc basis to accomplish specific tasks.

Further, various embodiments of the present invention can enhance many of the consumer electronics equipment and offerings, such as (1) providing upgrades and new offerings to the users for post sale revenue; (2) providing ease of registration for new products, as an alternative to filling out registration cards; and (3) providing location identification capability for the consumer electronics product for use by the service provider.

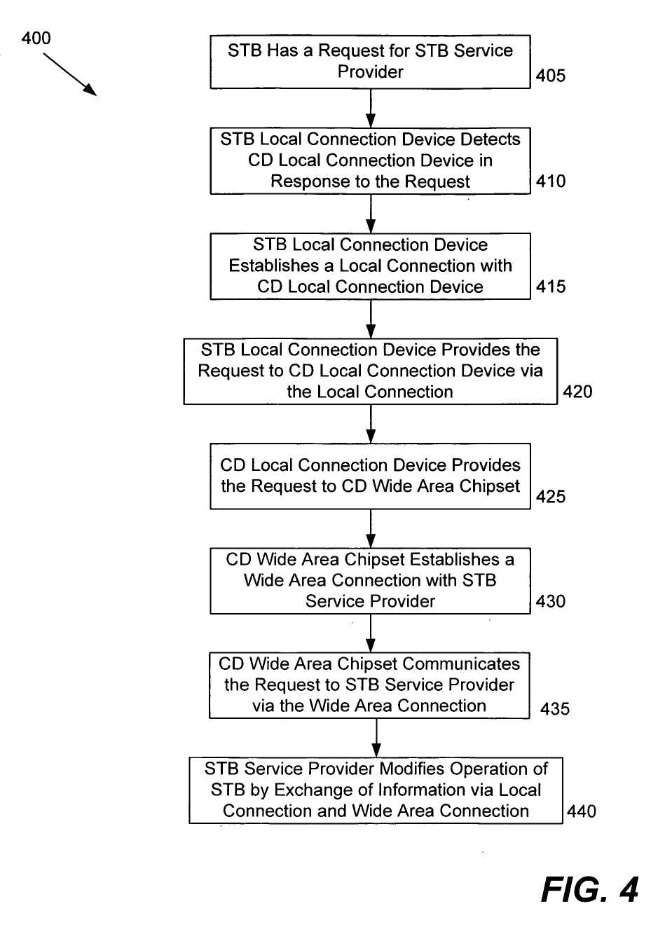

Turning to FIG. 4, it illustrates process flow diagram 400 for use by a communication system for facilitating a communication between an STB and an STB service provider via a local connection and a wide area connection, in accordance with one embodiment of the present invention. As shown, process 400 begins at step 405, where the STB has a request for the STB service provider. In one embodiment, such request may be received by the STB from a user, such as a request for additional or modified services, pay-per-view movie, status, STB reset, etc. In another embodiment, such request may be automatically generated by the STB for periodic update, upgrade or maintenance.

Continuing with process 400, at step 410, in response to the request, an STB local connection device starts looking for a local connection device of a communication device (CD). In one embodiment, the detection process may include detecting a bluetooth-enabled communication device, such as a bluetooth-enabled cellular phone. In other embodiments, step 410 may include detecting an 802.11-enabled communication device, etc. Next, at step 415, after detecting the CD local connection device, the STB local connection device establishes a local connection with the CD local connection device, in accordance with the detected capability at step 410, such as a local connection based on bluetooth, 802.11.

At step 420, the STB local connection device communicates the request to the CD local communication device via the local connection. At step 425, the CD local communication device communicates the request to a wide area chipset of the communication device. In response, at step 430, the CD wide area chipset establishes a wide area connection with the STB service provider. Such wide area connection may be a cellular connection, a DSL connection, a cable connection, and the like. At step 435, the CD wide area chipset communicates the request to the STB service provider via the wide area connection, and at step 440, STB service provider modifies an operation of the STB by exchanging information via the wide area connection and the local area connection. In another embodiment, the exchange of information may occur through other communication means, such as a cable or satellite connection between the STB and the STB service provider. Exchange of information between the communication device and the STB service provider may be achieved using tones, text messaging or data services, as discussed above. Further, in other embodiments, consumer electronics products other than set top boxes may also utilize process 400.

From the above description of the invention it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for use by a consumer electronics product (CEP) for communicating information with a CEP service provider, the method comprising:
providing a request by a CEP device to a CEP local communication device for a local area connection;
detecting a local-area-enabled communication device by the CEP local communication device in response to the request;
establishing a local area connection with the local-area-enabled communication device after the detecting;
causing the local-area-enabled communication device to establish a wide area connection with the CEP service provider;
providing the information to the CEP service provider via the local area connection and the wide area connection.

2. The method of claim 1, wherein the CEP is a set top box.

3. The method of claim 1, wherein the local area connection is based on one of a bluetooth connection or an 802.11 connection.

4. The method of claim 1, wherein the providing includes transmitting the information to the CEP service provider using a plurality of tone.

5. The method of claim 1, wherein the providing includes transmitting the information to the CEP service provider using a text message.

6. The method of claim 1, wherein the local-area-enabled communication device is a cellular phone.

7. The method of claim 1, wherein the providing includes transmitting the information to the CEP service provider using a data message via an electronic mail.

8. The method of claim 1 further comprising: providing location information to the CEP service provider.

9. The method of claim 8, wherein the location information indicates a location of the local-area-enabled communication device.

10. A method for use by a set top box (STB) for communicating information with STB service provider, the method comprising:
providing a request by an STB device to an STB bluetooth device for a bluetooth connection;
detecting a bluetooth-enabled communication device by the STB bluetooth device in response to the request;
establishing a bluetooth connection with the bluetooth-enabled communication device after the detecting;
causing the bluetooth-enabled communication device to establish a wide area connection with the STB service provider;
providing the information to the STB service provider via the bluetooth connection and the wide area connection.

11. The method of claim 10, wherein the providing includes transmitting the information to the STB service provider using a plurality of tone.

12. The method of claim 10, wherein the providing includes transmitting the information to the STB service provider using a text message.

13. The method of claim 10, wherein the bluetooth-enabled communication device is a cellular phone.

14. The method of claim 10, wherein the information includes a request for a pay-per-view event.

15. A set top box (STB) operable to communicate with a communication device (CD) having a CD bluetooth device and a CD wide area communication device, the STB comprising:
an STB device for operation of the STB;
an STB bluetooth device configured to detect the CD bluetooth device, in response to a request from the STB device, and to establish a bluetooth connection with the CD bluetooth device after detecting the CD bluetooth device, and to cause an establishment of a wide area connection between the CD wide area communication device and an STB service provider;
wherein the STB device is operable to transmit information to the STB service provider via the bluetooth connection and the wide area connection.

16. The STB of claim 15, wherein the STB device is configured to transmit the information to the STB service provider using a plurality of tone.

17. The STB of claim 15, wherein the STB device is configured to transmit the information to the STB service provider using a text message.

18. The STB of claim 15, wherein the communication device is a cellular phone.

19. The STB of claim 15, wherein the information includes a request for a pay-per-view event.
